(19) United States
(12) Patent Application Publication
(10) Pub. No.: US 2024/0227825 A1
(43) Pub. Date: Jul. 11, 2024

(54) TESTING MIXED SAFETY SYSTEMS

(71) Applicant: QUALCOMM Incorporated, San Diego, CA (US)

(72) Inventors: Amit ANEJA, Chandler, AZ (US); Rahul GULATI, San Diego, CA (US)

(21) Appl. No.: 18/152,222

(22) Filed: Jan. 10, 2023

(51) Int. Cl. B60W 50/02; B60W 50/00; B60W 50/035; G07C 5/08

(52) U.S. Cl. CPC B60W 50/0205; B60W 50/0098; B60W 50/035; G07C 5/085

(57) ABSTRACT

Aspects of the present disclosure provide techniques and apparatus for testing a mixed safety system, such as system included in a vehicle. An example method of operating a vehicle includes operating an electronic control unit (ECU) in a first state; detecting one or more criteria being satisfied to perform a test associated with the ECU; and performing the test associated with the ECU in response to detecting the one or more criteria being satisfied, while the ECU is in a second state different from the first state.

### BACKGROUND

### Field of the Disclosure

Certain aspects of the present disclosure generally relate to electronic components, and more particularly to a system-on-a-chip (SoC) with mixed safety functionality.

### Description of Related Art

Over the past several years, the automobile has been transformed from a self-propelled mechanical vehicle into a powerful and complex electro-mechanical system that includes a large number of sensors and processors that control many of the vehicle's functions, features, and operations. Vehicles may be equipped with a vehicle control system, which may be configured to collect and use information from the vehicle's various systems and sensors to automate all or a portion of the vehicle's operations. For example, an advanced driver assistance system (ADAS) may automate, adapt, or enhance the vehicle's operations. The ADAS may use information collected from the sensors (e.g., accelerometer, radar, lidar, geospatial positioning, etc.) to automatically detect a potential road hazard, and assume control over all or a portion of the vehicle's operations (e.g., braking, steering, etc.) to avoid detected hazards. Features and functions commonly associated with an ADAS include adaptive cruise control, automated lane detection, lane departure warning, automated steering, automated braking, and automated collision avoidance.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide a method of operating a vehicle. The method generally includes operating an electronic control unit (ECU) in a first state; detecting one or more criteria being satisfied to perform a test associated with the ECU; and performing the test associated with the ECU in response to detecting the one or more criteria being satisfied, while the ECU is in a second state different from the first state.

Certain aspects of the present disclosure provide an apparatus for operating a vehicle. The apparatus generally includes an ECU. The ECU is configured to operate in a first state, detect one or more criteria being satisfied to perform a test associated with the ECU, and perform the test associated with the ECU in response to detecting the one or more criteria being satisfied, while the ECU is in a second state different from the first state.

Certain aspects of the present disclosure provide an apparatus for operating a vehicle. The apparatus generally includes means for operating an ECU in a first state; means for detecting one or more criteria being satisfied to perform a test associated with the ECU; and means for performing the test associated with the ECU in response to detecting the one or more criteria being satisfied, while the ECU is in a second state different from the first state.

Certain aspects of the present disclosure provide a computer-readable medium having instructions stored thereon for operating an electronic control unit (ECU) in a first state; detecting one or more criteria being satisfied to perform a test associated with the ECU; and performing the test associated with the ECU in response to detecting the one or more criteria being satisfied, while the ECU is in a second state different from the first state.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example vehicle with a vehicle control system.

FIG. 2 is a block diagram of example components and interconnections in a system-on-a-chip (SoC).

FIG. 3 is a block diagram of an example SoC-based electronic control unit (ECU) in communication with one or more other ECUs.

FIG. 4 is an example timeline illustrating test(s) being performed opportunistically in a testing state associated with an ECU.

FIG. 5 is a flow diagram depicting example operations for testing an ECU.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure relate to methods and apparatus for performing tests associated with a system-on-a-chip (SoC).

Certain vehicles come with multiple features for safety, navigation, entertainment, etc., such as an advanced driver assistance system (ADAS), automated driving (AD), and/or in-vehicle infotainment (IVI). Some vehicles are able to sense and/or communicate with other vehicles and/or objects on the road, which allows for improvement in predictive safety features and AD. IVI is no longer just for entertainment purposes and may ideally work hand-in-hand with safety features, including an ADAS, especially as some vehicles are equipped with AD capabilities. As the automotive industry is transitioning to AD vehicles, ADASs are merging with IVI. Merging ADAS and IVI will improve drive safety, and improve the overall driving experience. Stated differently, as the driving experience becomes autonomous there is an increased demand for both passenger safety and entertainment.

Safety systems (e.g., certain ADAS and/or AD systems) may perform built-in self-tests (BISTs) to ensure the operational integrity of certain electrical components, such as memory, a processor, control logic, a power management circuit, a voltage regulator, etc. ADAS and/or AD systems have generally increased driver and passenger safety, but can cause harm to passengers or bystanders if these systems malfunction. The BISTs may be performed at system power-on checking the structural integrity of flops, gates, memory cells, for example. Safety and automotive SoCs may launch and execute such BISTs at system power-down, system power-up, or complete execution of all tests in a combination of at system power-up and system power-down. SoC safety mechanisms (e.g., memory error detection circuits) may be tested for correct operation at system boot time using techniques like fault injection. Such tests can increase the overall boot time especially as the SoCs increase in complexity and/or functionality. More safety subsystems within a SoC may translate into performing tests to verify the operation of safety subsystems and safety mechanisms during system boot and initialization. Safety hardware before running safety applications may be tested and checked to ensure absence of random hardware faults impacting safe operation. Measures to detect such faults are designed in line with a particular automotive safety integrity level (ASIL), for example, as per functional safety standard, such as ISO 26262 as provided by the International Organization for Standardization (ISO).

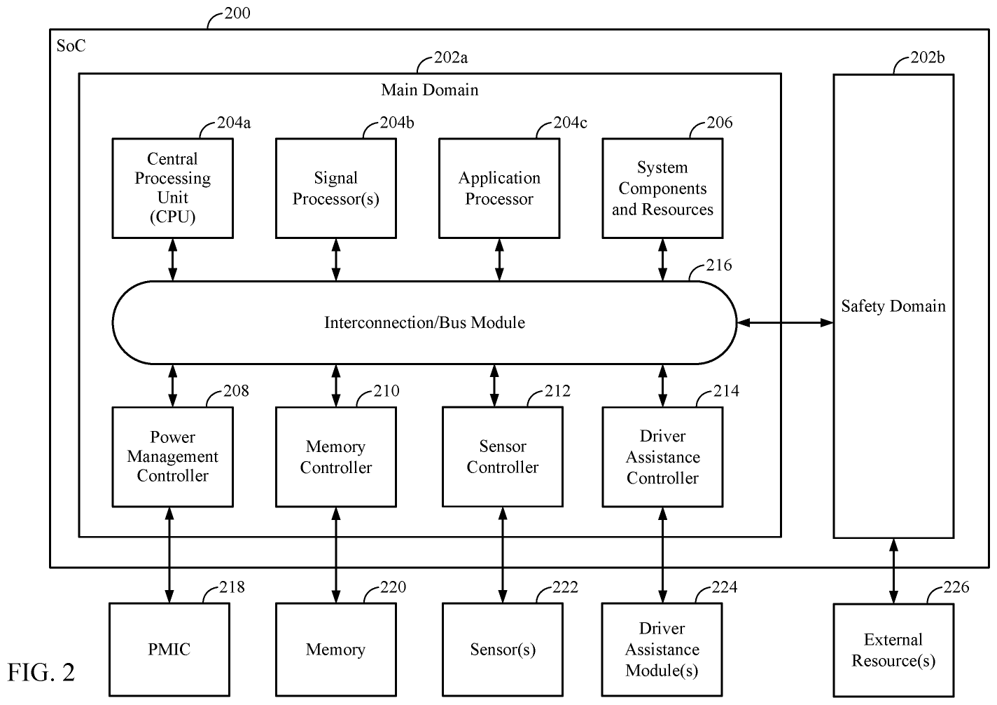

Increasingly, automotive compute architectures are becoming more centralized into a multi-functional SoC architecture. For example, certain safety features (e.g., ADAS and/or AD) and certain non-safety features (e.g., IVI) may be fused into a single centralized electronic control unit (ECU), such as a single SoC as further described herein with respect to FIG. 2. The centralized ECU may have a safety application and a non-safety application co-existing on the same ECU hardware and software platform. Such a centralized ECU may be referred to as a mixed safety ECU or SoC.

Non-safety applications on a mixed safety ECU may be expected to resume or boot very quickly after the user performs a vehicle key-on action (e.g., on the order of 100s of milliseconds). For example, the ECU may quickly resume operations for smartphone integration and features (e.g., Android Auto and/or Apple CarPlay), vehicle comfort controls and displays, etc. Very fast boot and resume latencies (e.g., less than 1 or 2 seconds) may be achieved through resuming from a suspended state (e.g., a suspend-to-random access memory (RAM)), where context is saved after a first full boot cycle and subsequently fast resume from RAM is performed.

Safety applications on a mixed safety ECU may be expected to resume or boot after a user performs a vehicle key-on action within a specified time. Certain safety applications (e.g., rearview camera display) may be specified (by regulations or industry standards) to be available to the driver within a certain duration (e.g., two seconds) from vehicle key-on. For example, in the United States, Federal Motor Vehicle Safety Standard (FMVSS) No. 111 specifies that a rearview image is to be displayed within 2 seconds of the vehicle's direction selector being placed in reverse. In certain cases, ADAS and/or AD applications that support automated driving may be responsive within 2 seconds. As ADAS and/or AD systems may undergo BIST and other safety checks at power-on or initialization, such tests may interfere with fast boot and resume latencies for mixed safety ECUs.

Aspects of the present disclosure provide methods and apparatus for performing tests associated with a SoC, such as a mixed safety ECU. For example, a SoC may perform certain tests (e.g., BIST(s) and checking the operation of BIST(s)) periodically, for example, every 24 hours or after a certain number of actions (e.g., key-on actions) have been performed. For example, the SoC may perform the tests when the vehicle is not in use or in response to the vehicle being turned off, and the SoC may store the test results in memory to be checked at the next key-on action. The SoC may resume from a suspended state (e.g., a suspend-to-RAM state) to enable a fast boot time for safety and non-safety applications. It will be appreciated that the methods and apparatus for performing tests associated with a mixed safety ECU described herein are merely examples of a testing framework. Aspects of the present disclosure may be further designed and/or implemented at the direction of the original equipment manufacturer (such as when and how often certain tests (including BIST) will be performed) based on certain system safety concepts and/or goals of the manufacturer.

The methods and apparatus for performing tests associated with a SoC described herein provide various advantages. The methods and apparatus described herein may enable a fast resume or boot time and ensure the operational integrity of the hardware and/or software that runs safety and non-safety applications.

### Example Vehicle Control System

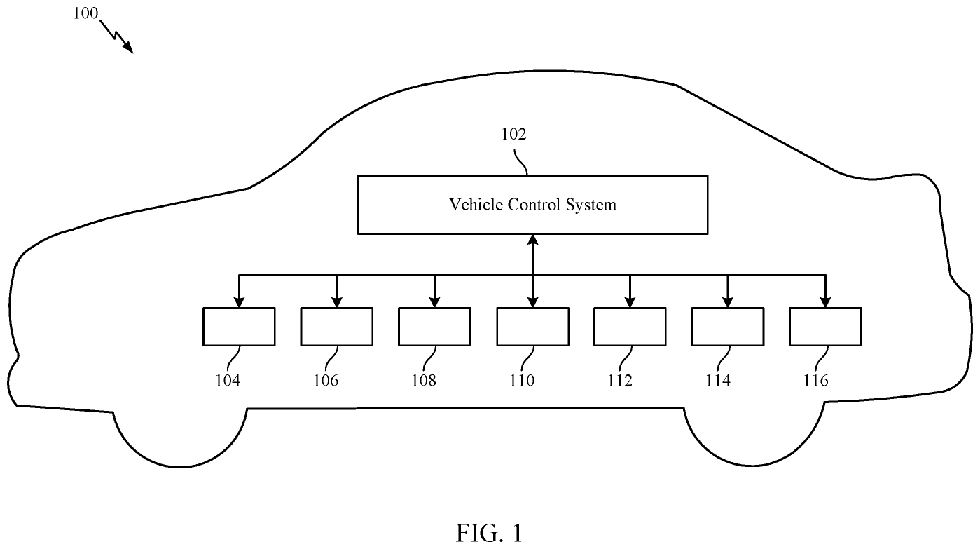

FIG. 1 is a block diagram of an example vehicle 100 including a vehicle control system 102 and various sensors suitable for controlling certain systems, such as an ADAS, an AD, and/or an IVI. The vehicle 100 may refer to a means of carrying or transporting something (e.g., a person or cargo). In some aspects, the vehicle 100 may represent a motor vehicle, such as a car, van, truck, semitruck, motorcycle, motorbike, moped, electric bicycle, etc. The vehicle 100 may be a series production road vehicle having safety-related systems that include one or more electrical and/or electronic systems, as further described herein. The vehicle 100 may use an internal combustion engine, an electric motor, or a hybrid propulsion system (e.g., a combination of an engine and an electric motor) for propulsion. In some cases, the vehicle 100 may have one or more electrical and/or electronic systems that comply with certain functional safety standards, such as ISO 26262 as provided by the International Organization for Standardization (ISO).

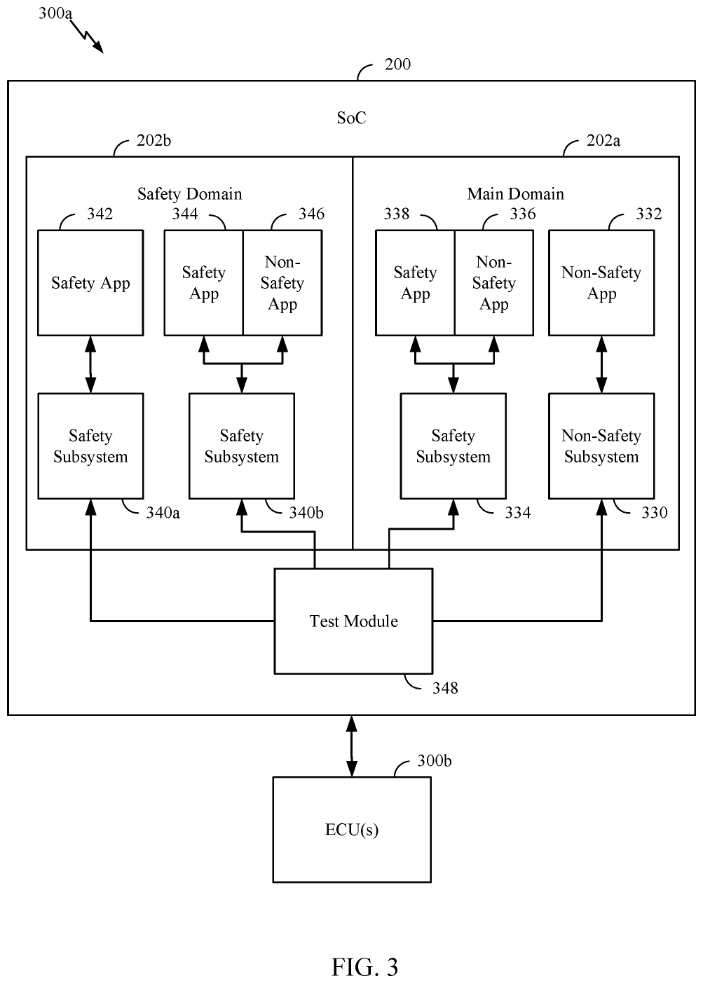

The vehicle control system 102 may include one or more computing devices having SoCs (e.g., one or more ECUs) as further described herein with respect to FIGS. 2 and 3. The vehicle control system 102 may be coupled to a variety of vehicle systems and subsystems, such as an environmental system 104 (e.g., an air conditioning and/or heating system), a navigation system 106, a communications and/or infotainment system 108, a power control system 110, a drivetrain control system 112, a driver assistance and/or automated driving control system 114, and/or a variety of sensors 116. Each vehicle systems and sensors 102-116 may communicate with one or more other systems via one or more communication links, which may include wired communication links (e.g., a Controller Area Network (CAN) protocol compliant bus, Universal Serial Bus (USB) connection, Ethernet connection, universal asynchronous receiver-transmitter (UART), etc.) and/or wireless communication links (e.g., a Wi-Fi® link, Bluetooth® link, ZigBee® link, ANT+® link, etc.).

The vehicle control system 102 may perform certain operations associated with any of the vehicle systems and subsystems. For example, the vehicle control system 102 may control or initiate the power-on and/or shutdown sequence for any of the vehicle systems and subsystems. The vehicle control system 102 may monitor for errors associated with any of the vehicle systems and subsystems, and in some cases, the vehicle control system 102 may store the errors for vehicle diagnostics. In response to any errors detected, the vehicle control system 102 may perform certain actions, such as shutting down the affected system or transferring some of the affected operations to be performed at a different vehicle system. The vehicle control system 102 may monitor the power levels supplied to any of the vehicle systems and subsystems and ensure that the power levels supplied satisfy the operating specifications for any of the vehicle systems and subsystems.

The environmental system 104 may control the cooling and/or heating systems associated the vehicle 100. For example, the vehicle 100 may have an air conditioning system, a heating system, heated or cooled seat(s), and/or a heated steering wheel; and the environmental system 104 may adjust the temperature according to user (or default) settings for the respective cooling and/or heating components. The navigation system 106 may show the vehicle's location on a map and provide navigation information, such as directions to a destination, via a display (not shown).

The communications and/or infotainment system 108 may allow the user to access various information (e.g., navigation information, interior or exterior environmental information, ADAS information, etc.), applications, and/or entertainment or media content, such as music and/or videos. The communications and/or infotainment system 108 may allow the user to update or access settings associated with a variety of systems, such as the environmental system 104, the navigation system 106, ADAS, vehicle settings, etc. The communications and/or infotainment system 108 may allow the user and/or vehicle 100 to wirelessly communicate via an integrated modem of the vehicle or via the user's wireless communication device (e.g., a smartphone or tablet).

The power control system 110 may control the components that output power to move the vehicle, such as an internal combustion engine (e.g., adjusting the air-fuel ratio, boost pressure, valve timing, etc.), an electric power system (e.g., controlling regenerative braking, battery power output, battery charging, and/or battery cooling, etc.), and/or a hybrid power system (e.g., controlling regenerative braking, switching between battery power and engine power, battery charging, battery cooling, etc.). The drivetrain control system 112 may control the various components of the vehicle 100 that deliver power to the drive wheels. For example, the drivetrain control system 112 may control gear shifting in an automatic transmission. For a four-wheel drive vehicle, the drivetrain control system 112 may control the power ratio applied to the front and rear drive wheels.

The driver assistance and/or automated driving control system 114 may control various driver assistance features and functions, such as adaptive cruise control, automated lane detection, lane departure warning, automated steering, automated braking, and automated collision avoidance. The driver assistance and/or automated driving control system 114 may control automated driving at various levels of automation, such as any of the Society of Automotive Engineers (SAE) levels 1 through 5.

The variety of sensors 116 coupled to the vehicle control system 102 may include any of the vehicle's speedometer, a wheel speed sensor, a torquemeter, a turbine speed sensor, a variable reluctance sensor, a sonar system, a radar system, an air-fuel ratio meter, a water-in-fuel sensor, an oxygen sensor, a crankshaft position sensor, a curb feeler, a temperature sensor, a Hall effect sensor, a manifold absolute pressure sensor, various fluid sensors (e.g., engine coolant sensor, transmission fluid sensor, etc.), a tire-pressure monitoring sensor, a mass airflow sensor, a speed sensor, a blind spot monitoring sensor, a parking sensor, cameras, microphones, accelerometers, compasses, a global navigation satellite system (GNSS) receiver (e.g., a global positioning system (GPS) receiver or a Galileo receiver), and other similar sensors for monitoring physical or environmental conditions in and around the vehicle.

The aforementioned systems are presented merely as examples, and vehicles may include one or more additional systems that are not illustrated for clarity. Additional systems may include systems related additional other functions of the vehicular system, including instrumentation, airbags, cruise control, other engine systems, stability control parking systems, tire pressure monitoring, antilock braking, active suspension, battery level and/or management, and a variety of other systems.

### Example System-On-A-Chip

The term “system-on-a-chip” (SOC) is used herein to refer to a single integrated circuit (IC) chip that contains multiple resources and/or processors integrated on a single substrate or in a single package. A single SoC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, flash, etc.), and resources (e.g., timers, voltage regulators, oscillators, etc.). A SoC may also include software for controlling the integrated resources and processors, as well as for controlling peripheral devices.

FIG. 2 is a block diagram of example components and interconnections in a system-on-a-chip (SoC) 200 suitable for implementing various aspects of the present disclosure. The SoC 200 may include multiple processing domains having, for example, a main domain 202a and a safety domain 202b (also referred to as a “safety island (SAIL)”). The main domain 202a may be configured to support (or capable of performing) vehicle operations (e.g., driver assistance and/or automated driving operations, features, etc.) up to a specific automotive safety integrity level (ASIL), and the safety domain 202b may be configured to support (or capable of performing) vehicle operations up to a lower, the same, or a higher ASIL than the main domain 202a. For example, the main domain 202a may be configured to support (or capable of performing) vehicle operations up to an ASIL B, and the safety domain 202b may be configured to support vehicle operations up to an ASIL D. In some cases, the main domain 202a may be configured to support (or capable of performing) vehicle operations up to an ASIL A, B, C, or D; and the safety domain 202b may be configured to support vehicle operations up to a different ASIL than the main domain 202a. In certain cases, the main domain 202a and the safety domain 202b may be configured to support (or capable of performing) vehicle operations at the same ASIL (e.g., ASIL D). The main domain 202a and the safety domain 202b may be configured to support (or capable of performing) vehicle operations at different ASILs.

The ASILs may be defined in a specific safety standard, such as ISO 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures.

In certain aspects, the SoC 200 may be included in a computing device (e.g., an ECU) in a vehicle control system. The SoC 200 may control any of the systems described herein with respect FIG. 1. For example, the SoC 200 may be configured to control an ADAS/AD system, such as the driver assistance and/or automated driving control system 114 described herein with respect to FIG. 1. In certain aspects, the SoC 200 may be in communication with other ECU(s) in a vehicle control system, as further described herein with respect to FIG. 3. For example, the main domain 202a may control the environmental system, the infotainment system, and driver assistance features up to a certain ASIL; and the safety domain 202b may control driver assistance features up to a certain ASIL, which may typically be higher than the main domain 202a.

The main domain 202a and/or safety domain 202b may include a number of heterogeneous processors 204a-c (collectively processors 204), such as a central processing unit (CPU) 204a, signal processor(s) or other specialized processor(s) 204b (e.g., a digital signal processor, an image signal processor, a neural network signal processor, computer vision processor, a graphics processing unit (GPU), etc.), and/or an application processor 204c. Each processor 204 may include one or more cores, and each processor/core may perform operations independent of the other processors/cores. Each processor 204 may be part of a subsystem (not shown) including one or more processors, caches, etc. configured to handle certain types of tasks or computations. It should be noted that the main domain 202a and/or safety domain 202b may include additional processors (not shown) or may include fewer processors (not shown). The main domain 202a and/or safety domain 202b may include other processors (e.g., a graphics processing unit, a vision processing unit, etc.) in addition to or instead of those illustrated.

The main domain 202a and/or safety domain 202b may include system components and resources 206 for performing certain specialized operations, such as analog-to-digital conversions and/or wireless data transmissions. The system components and resources 206 may include components such as voltage regulators, oscillators, phase-locked loops, peripheral bridges, data controllers, system controllers, access ports, timers, and other similar components used to support the processors and software clients running on the SoC 200. The system components and resources 206 may include circuitry for interfacing with peripheral devices, such as cameras, electronic displays, wireless communication devices, external memory chips, etc.

The main domain 202a and/or safety domain 202b may further include a power management controller 208, a memory controller 210 (e.g., a dynamic random access memory (DRAM) memory controller and/or a non-volatile memory controller), a sensor controller 212, and/or a driver assistance controller 214. The main domain 202a and/or safety domain 202b may also include an input/output (IO) module (not shown) for communicating with resources external to the SoC, such as a clock and a voltage regulator, each of which may be shared by two or more of the internal SoC components. The IO module may include a general purpose IO (GPIO) interface, for example. In certain aspects, each of the main domain 202a and the safety domain 202b may have a separate clock to facilitate independent operability.

The processors 204 of the main domain 202a may be interconnected to the system components and resources 206, the power management controller 208, the memory controller 210, the sensor controller 212, the driver assistance controller 214, other system components, and/or the safety domain 202b via an interconnection/bus module 216, which may include an array of reconfigurable logic gates and/or implement a bus architecture (e.g., CoreConnect, advanced microcontroller bus architecture (AMBA), etc.). Communications may be provided by advanced interconnects, such as high performance networks-on-chip (NoCs).

The interconnection/bus module 216 may include or provide a bus mastering system configured to grant SoC components (e.g., processors, peripherals, etc.) exclusive control of the bus (e.g., to transfer data) for a set duration, number of operations, number of bytes, etc. In certain aspects, the bus module 216 may include a direct memory access (DMA) controller (not shown) that enables components connected to the bus module 216 to operate as a master component and initiate memory transactions. The bus module 216 may implement an arbitration scheme to prevent multiple master components from attempting to drive the bus simultaneously.

The power management controller 208 may manage the power supplied to the main domain 202a from a PMIC 218, which may be representative of one or more PMIC(s). The power management may be separate and independent between the main domain 202a and the safety domain 202b.

The memory controller 210 may be a specialized hardware module configured to manage the flow of data to and from a memory 220. The memory controller 210 may include logic for interfacing with the memory 220, such as selecting a row and column in a cell array of the memory 220 corresponding to a memory location, reading or writing data to the memory location, etc. The memory 220 may be an on-chip component (e.g., on the substrate, die, integrated chip, etc.) of the SoC 200, or alternatively (as shown) an off-chip component.

The sensor controller 212 may manage the sensor data received from various sensors 222, such as the sensors 116. The sensor controller 212 may include circuitry for interfacing with the sensors 222. For example, the sensor controller 212 may receive sensor data from a tire pressure monitoring system and/or a radar sensor used for adaptive cruise control.

The driver assistance controller 214 may control certain driver assistance functions via a driver assistance module 224 (e.g., one or more actuators, relays, switches, etc.). For example, the driver assistance controller 214 may control the adaptive cruise control by controlling actuators coupled to the engine and/or braking system. In some cases, the driver assistance controller 214 may perform automated steering by controlling actuators attached to the steering system. It will be appreciated that the driver assistance controller 214 is merely an example, and the main domain 202a and/or the safety domain 202b may include a controller that interfaces with automated driving components in addition to or instead of the driver assistance controller 214.

The SoC 200 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, temperature, etc.), cameras, compasses, GPS receivers, communications circuitry (e.g., Bluetooth®, wireless local area network (WLAN), Long Term Evolution (LTE), Fifth Generation New Radio (5G NR), etc.), and other well-known components (e.g., accelerometer, etc.) of modern electronic devices.

Each of the processing domains may operate independently of the other domains. In some cases, each of the processing domains may be coupled to separate and independent external resources, such as a PMIC, memory, sensor(s), and driver assistance module(s). A particular external resource may be designed in accordance with an ASIL corresponding to the particular ASIL associated with the main domain 202a and/or the safety domain 202b to which the external resource is coupled. For example, the PMIC 218 may have the same ASIL as the main domain 202a, and the PMIC that provides power to the safety domain 202b may have the same ASIL as the safety domain 202b. The safety domain 202b may include the same or different processing resources and components as the main domain 202a as described herein with respect to the main domain 202a. For example, the safety domain 202b may include the processors 204, the system components and resources 206, the power management controller 208, the memory controller 210, the sensor controller 212, and the driver assistance controller 214. The safety domain 202b may be coupled to certain external resource(s) 226, which may be representative of a PMIC, memory, sensors, and/or driver assistance module, for example, as described herein with respect to the main domain 202a.

In addition to the SoC 200 discussed above, various aspects may be implemented in a wide variety of computing systems, which may include a single processor, multiple processors, multicore processors, or any combination thereof.

### Example Testing a Mixed Safety System

FIG. 3 is a block diagram of an example SoC-based ECU 300a in communication with one or more other ECUs 300b. In this example, the ECU 300a and the other ECU(s) 300b may operate in a vehicle control system and/or any vehicle system or subsystem, as described herein with respect to FIG. 1. The ECU 300a may perform some vehicle control operations (e.g., infotainment, environmental, ADAS, etc.); and the other ECU(s) 300b may perform some vehicle control operations (e.g., system wide controls, engine controls, drivetrain controls, other ADAS features, etc.). As an example, the ECU 300a may be a mixed safety ECU, for example, having the main domain 202a and the safety domain 202b. The ECU 300a may include the SoC 200 and corresponding external resources (not shown) as described herein with respect to FIG. 2. In some aspects, the other ECU(s) 300b may include a SoC-based ECU, such as the SoC 200 and corresponding external resources as described herein with respect to FIG. 2.

The main domain 202a may have a non-safety subsystem 330 that executes a non-safety application (app) 332 (e.g., an IVI application such as climate controls). In some cases, the main domain 202a may have a safety subsystem 334a that executes another non-safety application 336 (e.g., an IVI application such as an audio system) and a safety application 338 (e.g., an ADAS application such as a blind spot monitoring). The safety domain 202b may have safety subsystems 340a, 340b (collectively safety subsystems 340), where the first safety subsystem 340a may execute a first safety application 342 (e.g., an ADAS application such as an adaptive cruise control system), and the second safety subsystem 340b may execute a second safety application 344 (e.g., an ADAS application such as lane departure warning and/or correction) and a non-safety application 346 (e.g., an IVI application such as smartphone integration). It will be appreciated that the subsystems 330, 334, 340 are merely examples of a mixed safety system, where a particular domain or domains of an ECU may be responsible for executing safety and non-safety applications. Other subsystem architectures distributed across the main domain 202a and/or safety domain 202b may be used in addition to or instead of those illustrated in FIG. 3.

In some cases, the safety subsystem(s) and corresponding safety application(s) may execute safety-critical (e.g., life-critical) function(s) or feature(s), where a failure or malfunction associated with the safety subsystem and/or safety application may result in violation of a safety goal, death or serious injury to a person (e.g., the driver, operator, or passenger), loss or severe damage to property, or an environmental harm. A safety goal may include a top-level safety standard or requirement as a result of the hazard analysis and risk assessment at the vehicle level.

In certain aspects, the ECU 300a may include a test module 348 that performs tests on any of the various subsystems 330, 334, 340. Fault(s) in electrical or electronic components can happen due to various reasons. The test(s) described herein may allow for timely (and proactive) detection of such faults through safety mechanisms such that driver could be alerted so as to not rely on ADAS features or systems that have been detected to be malfunctioning, or have the system enter other safe states to avoid hazard. For example, the test module 348 may perform BISTs on any of the various subsystems 330, 334, 340. The test module 348 may perform a BIST on any of various electrical components (not shown) of the subsystems 330, 334, 340, such as memory (e.g., the memory controller 210 and/or memory 220), a processor (e.g., the processors 204), control logic, a power management circuit (e.g., the power management controller 208 and/or PMIC 218), a voltage regulator, etc. The test module 348 may perform tests on any of various software components or modules, such as testing certain software applications (ADAS applications), algorithms (e.g., common calculations), other software components (e.g., device drivers, operating system, etc.) as well for ensuring correct operation. The test module 348 may perform test(s) that verify the operational integrity of the BISTs, for example, via fault injection into the BISTs. For example, the test module 348 may perform a test that confirms that a BIST is operating correctly by injecting a known failure and/or a known success into the BIST and verifying that a failure or a success is output or reported.

In aspects, the test module 348 may include a processor, a digital signal processor (DSP), an application specific integrated circuit (ASIC), a field programmable gate array (FPGA) or other programmable logic device (PLD), discrete logic (e.g., gate or transistor logic), discrete hardware components (e.g., a comparator, a digital analog converter, a multiplexer, etc.), or any combination thereof designed to perform the functions described herein related to executing the tests. In certain aspects, the test module 348 may be integrated with another component, such as the processors 204, power management controller 208, memory controller 210, sensor controller 212, and/or driver assistance controller. In some aspects, the test module 348 may include computer-executable code that when executed by a processor causes the processor to perform the test(s) described herein. In certain aspects, the test module 348 may be representative of one or more circuits, circuit packages, circuit boards, and/or software modules or packages. The test module 348 may be representative of multiple hardware and/or software components included in the ECU 300a.

To ensure a fast boot in response to a key-on action (or another action), the ECU 300a may resume from a suspended state (e.g., a suspend-to-RAM (STR) state) for the non-safety application 332, 338 and/or the safety applications 336 on a mixed safety ECU. Resuming from the suspended state may allow the ECU 300a to resume within an expected duration from the key-on action (e.g., 100s of milliseconds). Resuming from the suspended state may enable a fast resume or boot time, and performing the test(s) described herein may ensure the operational integrity of the hardware and/or software that runs safety and non-safety applications.

The ECU 300a may perform test(s) (e.g., a BIST for logic, memory, and/or other electrical components) opportunistically at certain occasions when the vehicle is in a specific testing state. As an example, the testing state may include when the vehicle is not in use, when the vehicle is stationary (or immobile or parked), when the vehicle is powering down (shutting off or transitioning to a suspended state in response to a key-off action), when the vehicle is in an off state, when the vehicle is being refueled or re-charged, or at a certain time of day (e.g., at certain times when the vehicle is immobile like at night parked at home or during the day parked at work).

The opportunistic testing may enable correct initialization of safety and non-safety context (including hardware and software) for execution on the same vehicle ECU after a vehicle key-on event or when the vehicle is operationalized for driving. The opportunistic testing may enable a low latency to restore system context stored in memory while ensuring functional safety related checks and initializations are performed to detect (random) hardware or software faults in the system. In some cases, the ECU 300a may perform the test(s) (e.g., BIST(s)) during context save phase every time the vehicle or ECU 300a is powering down or transitioning to the suspended state. The ECU 300a may ensure the vehicle is in the testing state by waiting a certain period after the driver performs the key-off action. The ECU 300a may implement a point of no-return after the testing sequence is launched during power-down. For example, the ECU 300a may refrain from responding to a key-on action when performing the BISTs or wait until the BISTs are completed to trigger powering on the vehicle.

When the vehicle is in the testing state, the ECU 300a may perform the tests in response to certain criteria being satisfied such as the expiration of a timer and/or a counter matching a threshold, where the timer and/or counter may be reset upon execution of the tests. For example, the timer may be restarted upon execution of the tests, and the counter may be set to an initial value (e.g., zero) upon execution of the tests. In some cases, the ECU 300a may perform the tests periodically, for example, every time interval, such as a multiple-point fault detection interval (MPFDI). The time interval or the duration of the timer may be 24 hours, for example, or configured by the safety expectations of the original equipment manufacturer (OEM) of the vehicle. The time interval or the duration of the timer may be referred to as the MPFDI. The ECU 300a (or the other ECU(s) 300b) may keep track of the last performed test execution cycle via the timer and/or counter set relative to the last performed test. In certain aspects, the ECU 300a may ensure the vehicle is in a testing state, such as waiting an additional time interval (e.g., 1 to 2 seconds) before initiating the tests. The ECU 300a may have a residency counter or timer to wait the time interval (e.g., 1 to 2 second or a configurable duration) to ensure the driver does not perform an immediate key-on (after key-off).

As the ECU 300a may resume from a suspended state after performing the tests, the ECU 300a may store the test results (e.g., a BIST pass or fail) in non-volatile memory (e.g., the memory 220) or provide the test results to the other ECU(s) 300b. The ECU 300a may store the test results before transitioning to the suspended state. The ECU 300a may save the BIST status (e.g., pass or fail) and detailed BIST test results in memory for the ECU 300a to retrieve during context restore (e.g., during the next power on cycle of the ECU 300a). Subsequently, on a next key-on (power-on) cycle, the ECU 300a may check the test results to ensure the absence of any faults (such as a transient or permanent fault detected by the BIST tests). If an error is detected during the tests, the ECU 300a may perform any of various actions. In some cases, the ECU 300a may treat the error detected as being a permanent error without performing an additional test. In certain cases, the ECU 300a may perform additional tests while the vehicle is still in the testing state (e.g., immobile, not in use, or powered-down) or in a subsequent testing state. The ECU 300a may re-run the BIST to confirm the validity of test results if an error is detected. The additional tests may ensure the detected fault is not transient in nature and is a permanent fault. As a fault was detected in the testing state, upon resumption from the suspended state if the vehicle discovers the fault based on saved BIST test data, the vehicle may perform BIST tests to rule out permanent faults. The vehicle may not in this case provide flexibility or option to postpone such tests any further to power-down phase since that can pose a hazard.

In certain aspects, when a fault is detected, at the next key-on action (e.g., power-on) of the vehicle, the ECU 300a may refrain from booting, operating, or executing certain features or applications, such as ADAS, AD, or other application(s). In some cases, the ECU 300a may notify the other ECU(s) 300b that a fault was detected at the ECU 300a and that the ECU 300a will refrain from operating or executing certain features due to the fault. The other ECU(s) 300b may perform any of various actions, for example, as configured by the OEM. The other ECU(s) 300b may determine the response to the detected error according to the OEM safety policy. For example, the other ECU(s) 300b may display an error indication to the user or operator, or the other ECU(s) 300b may take over performing some of the features performed by the ECU 300a. In certain cases, when a fault is detected, the ECU 300a (and/or the other ECU(s) 300b) may notify an entity of the fault, for example, where the entity may be the OEM or a vehicle care service. As an example, upon detection of a permanent fault, the ECU 300a (and/or the other ECU(s) 300b) may inform the OEM via a wireless communication network (e.g., cellular communication). The OEM may launch and perform remote safety diagnostics for any potential recovery procedures. The OEM may perform remote diagnostics for possible recovery procedures.

In case an error or fault (e.g., an uncorrectable error or fault) is detected during the vehicle runtime (for example, outside of the testing state while the vehicle is mobile), the ECU 300a (and/or the other ECU(s) 300b) may undergo a specific action per an OEM safety policy including a shutdown, a reset, or transition to a safety state, such as semi-operational state where the ECU 300a performs limited tasks (e.g., refraining from performing any safety functions affected by the fault or error). The ECU 300a (and/or the other ECU(s) 300b) may execute a minimum risk maneuver, for example, according to a system safety concept designed by the OEM. The ECU 300a may not be allowed to enter and/or resume from the suspended state (e.g., STR) in this case as the error could be permanent, and instead, the ECU 300a may undergo a reset or transition to a safety or semi-operational state. The ECU 300a may transition to a context save or restore flow in cases where a reboot or BIST cycle will be performed in response to the detected fault. Execution of full system boot (instead of resuming from a suspended state) and safety initialization, including BISTs, after detection of a fault may allow verification of whether the fault is permanent or resolved due to the reboot.

In response to detecting the error or fault during the vehicle runtime, the ECU 300a may perform certain tests (e.g., BISTs) during the next testing state without waiting for the timer to expire and/or the counter to reach the threshold. If the tests pass (e.g., to undergo the test successfully without any failures), the ECU 300a may be allowed to enter a suspended state (e.g., STR). If the tests have any failures or detect any faults or errors, the ECU 300a may perform any of various actions as previously described herein with respect to detecting an error or fault.

Upon resuming from the suspended state (e.g., STR), the ECU 300a may perform any of certain safety checks before executing any safety applications (e.g., ADAS or AD features). The ECU 300a may perform a safe resume procedure (e.g., performing certain safety check(s)) for proper safety initialization and re-configuration of the SoC 200 upon resumption of safety and non-safety context from memory. Until the safety check(s) are completed and successful, the ECU 300a may remain in a suspended state or operate in a semi-operational state (e.g., running non-safety applications in the main domain 202a), and the ECU 300a may be prevented from executing any of the safety applications (e.g., the safety applications 336a, 336b). The ECU 300a may check correct operation of certain safety compute subsystem(s), safety interface(s), and/or safety communication channel(s). The ECU 300a may evaluate the results of the tests (e.g., BISTs) performed in the testing state as described herein.

The safety compute subsystem(s) may perform a set of (randomized) challenge-answer computational problems (e.g., calculations) to ensure the safety compute subsystem(s) can read data or instructions from memory and execute calculations. The safety compute subsystem(s) may check the correct operation of error correction code (ECC) associated with memory (e.g., the respective memory 220 of the safety domain 202b), for example, via fault injection. The safety compute subsystem(s) may include any of the processors associated with the safety domain 202b, such as any of the respective processor(s) 204, an application processor, neural network signal processor (NSP), a GPU, a computer vision processor (CVP), etc.

The ECU 300a may output and receive a test signal or pattern on any of the safety interface(s), for example, via a loopback. The safety interface(s) may include any of the communication interfaces associated with the safety domain 202b, such as a peripheral component interconnect (PCI) bus, PCI express (PCIe) bus, an Ethernet interface, CAN bus, serial peripheral interface (SPI) bus, a serial communication bus (e.g., an inter-integrated circuit (I2C) bus or USB), UART, etc. The safety interfaces may facilitate communication between the ECU 300a and peripheral components, such as the PMIC 218, memory 220, sensor(s) 222, and/or the driver assistance module(s) 224

The ECU 300a may check any of the safety communication channels. For example, the ECU 300a may send a test signal or pattern on any of the safety communication channels to ensure error-free communications, such as a handshake and/or error communications. The safety communication channels may include a communication channel between the main domain 202a and the safety domain 202b and/or between the ECU 300a and the other ECU(s) 300b.

In certain aspects, the safety checks performed while resuming from a suspended state may include verifying that the opportunistic tests (e.g., BISTs for hardware and/or software) performed during the testing state (e.g., BISTs) have been executed (within the correct time window) and/or enabled to be executed at the next testing interval. The safety checks may include a fault injection test on ECC logic. The safety checks may include execution of periodic tests associated with a safety test library (STL) in any of the safety subsystems, such as an application processor, GPU, NSP, CVP, or the safety domain.

Upon successful completion of the safety checks (e.g., without detecting any faults or errors), the ECU 300a may be released from the suspended state, and the ECU 300a may be allowed to initiate execution of any of the safety applications 336a, 336b.

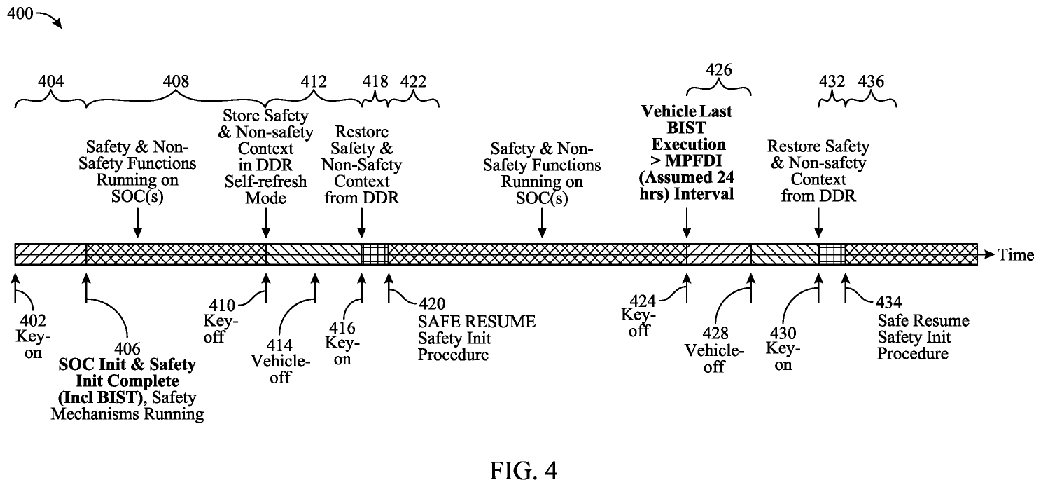

FIG. 4 illustrates an example timeline 400 for performing the tests opportunistically in a testing state associated with an ECU (e.g., the ECU 300a). At occasion 402, a key-on action may be performed, where the key-on action may trigger the vehicle (e.g., the vehicle 100) and corresponding ECU(s) (e.g., the ECU 300a) to perform a full boot sequence, for example, including performing any of the tests described herein, such as BIST(s) and/or BIST integrity check(s) (e.g., checking that the BIST(s) are operating as expected). The full boot sequence may be performed for the first time at the factory of manufacture, for example. The full boot sequence may be performed in the first time period 404. The key-on action may include any action that triggers the vehicle to power-on or resume from a suspended state, for example, via a remote start signal, a power button, or an ignition lock tumbler.

At occasion 406, the full boot sequence may be completed, and the vehicle may perform safety and non-safety functions in the second time period 408. For example, the vehicle may perform ADAS and/or AD function(s) using the safety domain 202b, and the vehicle may perform IVI function(s) via the main domain 202a. In the second time period 408, the vehicle and corresponding ECU(s) may be operating in a normal state (e.g., when the vehicle is fully operational and executing safety and non-safety functions).

At occasion 410, a key-off action may be performed, where the key-off action may trigger the vehicle and corresponding ECU(s) to transition to a suspended state (e.g., STR) in the third time period 412. The vehicle may store safety and non-safety context in memory (e.g., the memory 220 and/or the corresponding memory associated with the safety domain 202b). In certain aspects, the ECU 300a may store the results from the testing performed at the first full boot sequence in the first time period 404. At occasion 414, the vehicle may effectively be turned off in a suspended state. The key-off action may include any action that triggers the vehicle to power-down or transition to a suspended state, for example, via an automated power-down cycle, a power button, or an ignition lock tumbler.

At occasion 416, a key-on action may be performed, where the key-on action may trigger the vehicle and corresponding ECU(s) to resume from the suspended state allowing for a fast boot time (for example, less than 1 to 2 seconds) in the fourth time period 418. At occasion 420, an ECU (e.g., ECU 300a) may perform certain safety checks as described herein with respect to FIG. 3. The ECU may refrain from executing safety functions until the safety checks are completed, for example, in the fifth time period 422. Upon completion of the safety checks, the vehicle may perform safety and non-safety functions.

At occasion 424, a key-off action may be performed, where the key-off action may trigger the vehicle and corresponding ECU(s) to transition to a suspended state (e.g., STR). An ECU (e.g., the ECU 300a) may determine that the duration since the last BIST (performed at occasion 402) is greater than the MPFDI (e.g., 24 hours), and in response to this determination, the ECU may perform the BIST(s) while the ECU is in a testing state (e.g., when the vehicle is immobile) in the sixth time period 426. Performing the BIST(s) in the testing state allows the vehicle to resume quickly from the suspended state. If an error or fault is detected, the vehicle can perform the test again to determine whether the error or fault is persistent or transitory. In certain cases, the ECU may wait an additional duration (e.g., 1 to 2 seconds) to ensure the vehicle is in a testing state. In some cases, the ECU may wait until a certain time during the day to perform the BIST(s), such as after 12:00 am or 1:00 am, when the vehicle is most likely immobile. The ECU may store the test results associated with the BIST(s) in memory. At occasion 428, the vehicle may effectively be turned off in the suspended state.

At occasion 430, a key-on action may be performed, where the key-on action may trigger the vehicle and corresponding ECU(s) to resume from the suspended state in the seventh time period 432. An ECU may restore the safety and non-safety context from memory. The ECU may check the test results stored in memory to verify that no faults or errors were detected in the sixth time period as described herein. At occasion 434, the ECU may perform certain safety checks in the eighth time period 436 as described herein with respect to FIG. 3, and upon completion of the safety checks, the ECU may execute safety functions.

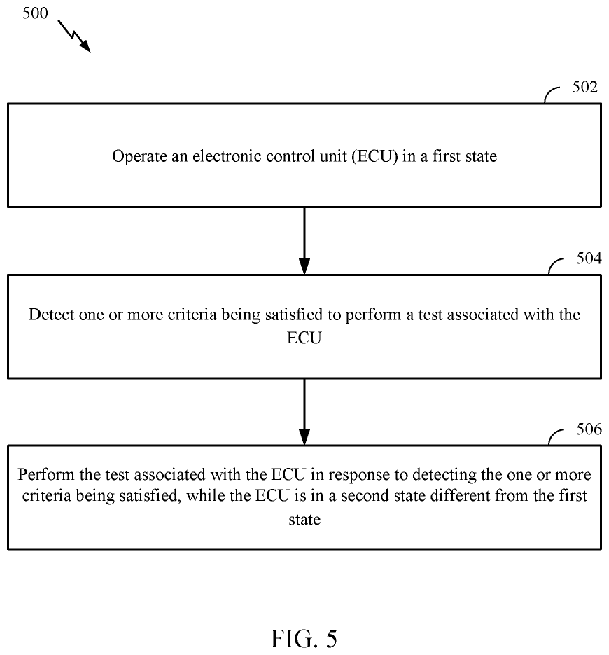

FIG. 5 is a flow diagram depicting example operations 500 for operating a vehicle (e.g., the vehicle 100). The operations 500 may be performed by a SoC (e.g., the SoC 200) or a SoC-based ECU (e.g., the ECU 300a of FIG. 3).

The operations 500 may optionally begin, at block 502, where the vehicle may operate an electronic control unit (ECU) in a first state. For example, the ECU may operate in a normal state as described herein with respect to FIG. 4. The normal state may include when the vehicle or the ECU is fully operational and executing safety and non-safety functions.

At block 504, the ECU may detect one or more criteria being satisfied to perform a test associated with the ECU. For example, the ECU may perform the test opportunistically without disrupting a boot sequence of the ECU, as described herein with respect to FIGS. 3 and 4.

At block 506, the ECU may perform the test associated with the ECU in response to detecting the one or more criteria being satisfied, while the ECU is in a second state different from the first state. The test may include a BIST or testing that the BIST is operating as expected, for example, via fault injection. To perform the test, the ECU may perform a BIST associated with one or more electrical components or one or more software components of the ECU. The one or more electrical components may include at least one of a memory (e.g., the memory 220), a processor (e.g., any of the processors 204), control logic (e.g., the memory controller 210 or sensor controller 212), a power management circuit (e.g., the PMIC 218), or a voltage regulator (e.g., a voltage regulator in the PMIC 218), for example.

The second state may include a testing state, for example, as described herein with respect to FIGS. 3 and 4. The second state may include when the vehicle or the ECU is being powered off (e.g., a key-off action may trigger a transition to the second state), when the vehicle or the ECU is in a suspended state (e.g., STR), when the vehicle or the ECU is not in use for a duration, when the vehicle or the ECU is in a low power mode, when the vehicle or the ECU is immobile for the duration, when the vehicle is refueling or re-charging, or any combination thereof.

In certain aspects, the ECU may determine when to perform the test, for example, based on the one or more criteria. The one or more criteria may comprise the vehicle or the ECU transitioning to being powered off, the vehicle or the ECU transitioning to being in a suspended state, or the vehicle or the ECU transitioning to being in a low power mode. In certain aspects, the one or more criteria may be relative to when the test was last performed. The one or more criteria may be satisfied when a timer (e.g., MPFDI) expires or when a counter reaches a threshold value. The ECU may restart the timer or reset the counter, in response to performing the test associated with the ECU.

For certain aspects, the ECU may store a result (e.g., a pass or fail) associated with the test in a memory (e.g., the memory 220). The ECU may check the stored result in response to obtaining an indication to resume the ECU from a suspended state. The indication to resume the ECU may include a key-on action as described herein with respect to FIGS. 3 and 4. The ECU may perform one or more actions in response to checking the result.

In certain aspects, the ECU may perform any of certain safety checks in response to resuming from the suspended state. The ECU may perform one or more safety checks associated with the ECU while the ECU is in the suspended state and prevented from executing a safety application. The safety checks may include checking certain safety compute subsystem(s), safety interface(s), and/or safety communication channel(s) as described herein with respect to FIG. 3. The ECU may be allowed to resume from the suspended state in response to (successfully) completing the one or more safety checks.

For certain aspects, the ECU may perform any of various actions in response to detecting an error or a fault from the test. The ECU may determine that the result indicates an error associated with the ECU. The ECU may perform a subsequent test (e.g., BIST) in response to determining that the result indicates the error. The ECU may store a result of the subsequent test in the memory. The ECU may provide, to one or more other ECUs (e.g., the other ECU(s) 300b) or an entity (e.g., the OEM), an indication that the result indicates an error associated with the ECU, and the ECU may be prevented from booting or resuming from the suspended state.

In certain aspects, the ECU may detect an error while in the first state and perform any of various actions. For example, the ECU may detect an error associated with the ECU while the ECU is operating in the first state. The ECU may be reset or shutdown (or perform a particular action per the OEM) in response to detecting the error. The ECU may detect an indication to power off the vehicle, and the ECU may perform another test associated with the ECU in response to detecting the error and to detecting the indication to power off the vehicle. The ECU may be allowed to enter the suspended state if the other test passes. The ECU may provide, to one or more other ECUs or an entity, an indication of the error associated with the ECU if the other test fails, and the ECU may be prevented from booting or resuming from the suspended state if the other test fails.

For certain aspects, the ECU may resume from a suspended state, for example, to enable a fast boot sequence. For example, the ECU may operate in the suspended state, where the suspended state includes a suspend-to-memory (e.g., random access memory (RAM) or other types of memory such as non-volatile memory, universal flash storage, an embedded multi-media-card (eMMC), PCIe, Ethernet based storage drive, etc.) state.

In certain aspects, the ECU may execute mixed safety functions including safety functions and non-safety functions, for example, as described herein with respect to FIGS. 2 and 3. For example, operating ECU in the first state may include performing, via the ECU, a safety operation (e.g., ADAS and/or AD) and a non-safety operation (e.g., IVI).

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, means for operating, means for detecting, means for performing, means for storing, means for checking, means for allowing, means for resetting, means for providing, means for preventing, may include a SoC (e.g., the SoC 200), a main domain of the SoC (e.g., the main domain 202a), a safety domain of the SoC (e.g., the safety domain 202b), and memory (e.g., the memory 220).

### Example Aspects

Implementation examples are described in the following numbered aspects:

Aspect 1: A method of operating a vehicle, comprising: operating an electronic control unit (ECU) in a first state; detecting one or more criteria being satisfied to perform a test associated with the ECU; and performing the test associated with the ECU in response to detecting the one or more criteria being satisfied, while the ECU is in a second state different from the first state.

Aspect 2: The method of Aspect 1, wherein performing the test comprises performing a built-in self-test (BIST) associated with one or more electrical components or one or more software components of the ECU.

Aspect 3: The method of Aspect 2, wherein the one or more electrical components include at least one of a memory, a processor, control logic, a power management circuit, or a voltage regulator.

Aspect 4: The method according to any of Aspects 1-3, wherein the second state comprises: the vehicle or the ECU being powered off, the vehicle or the ECU being in a suspended state, the vehicle or the ECU not being in use for a duration, the vehicle or the ECU being in a low power mode, or a combination thereof.

Aspect 5: The method according to any of Aspects 1-4, wherein the one or more criteria comprise: the vehicle or the ECU transitioning to being powered off, the vehicle or the ECU transitioning to being in a suspended state, or the vehicle or the ECU transitioning to being in a low power mode.

Aspect 6: The method according to any of Aspects 1-5, wherein the one or more criteria are relative to when the test was last performed.

Aspect 7: The method according to any of Aspects 1-6, wherein: the one or more criteria are satisfied when a timer expires or when a counter reaches a threshold value; and the method further comprises restarting the timer or resetting the counter, in response to performing the test associated with the ECU.

Aspect 8: The method according to any of Aspects 1-7, further comprising: storing a result associated with the test in a memory; checking the stored result in response to obtaining an indication to resume the ECU from a suspended state; and performing one or more actions in response to checking the result.

Aspect 9: The method of Aspect 8, wherein performing the one or more actions comprises: performing one or more safety checks associated with the ECU while the ECU is in the suspended state and prevented from executing a safety application; and allowing the ECU to resume from the suspended state in response to completing the one or more safety checks.

Aspect 10: The method of Aspect 8 or 9, further comprising: determining that the result indicates an error associated with the ECU; performing a subsequent test in response to determining that the result indicates the error; and storing a result of the subsequent test in the memory.

Aspect 11: The method according to any of Aspects 8-10, wherein performing the one or more actions comprises: providing, to one or more other ECUs or an entity, an indication that the result indicates an error associated with the ECU; and preventing the ECU from booting.

Aspect 12: The method according to any of Aspects 8-11, further comprising: detecting an error associated with the ECU while the ECU is operating in the first state; resetting or shutting down the ECU in response to detecting the error; detecting an indication to power off the vehicle; performing another test associated with the ECU in response to detecting the error and to detecting the indication to power off the vehicle; allowing the ECU to enter the suspended state if the other test passes; providing, to one or more other ECUs or an entity, an indication of the error associated with the ECU if the other test fails; and preventing the ECU from booting if the other test fails.

Aspect 13: The method according to any of Aspects 8-12, further comprising operating the ECU in the suspended state, wherein the suspended state includes a suspend-to-memory state.

Aspect 14: The method according to any of Aspects 1-13, wherein operating the ECU in the first state comprises performing, via the ECU, a safety operation and a non-safety operation.

Aspect 15: An apparatus for operating a vehicle, comprising: an electronic control unit (ECU) configured to: operate in a first state, detect one or more criteria being satisfied to perform a test associated with the ECU, and perform the test associated with the ECU in response to detecting the one or more criteria being satisfied, while the ECU is in a second state different from the first state.

Aspect 16: The apparatus of Aspect 15, wherein to perform the test, the ECU is configured to perform a built-in self-test (BIST) associated with one or more electrical components or one or more software components of the ECU.

Aspect 17: The apparatus of Aspect 16, wherein the one or more electrical components include at least one of a memory, a processor, control logic, a power management circuit, or a voltage regulator.

Aspect 18: The apparatus according to any of Aspects 15-17, wherein the second state comprises: the vehicle or the ECU being powered off, the vehicle or the ECU being in a suspended state, the vehicle or the ECU not being in use for a duration, the vehicle or the ECU being in a low power mode, or a combination thereof.

Aspect 19: The apparatus according to any of Aspects 15-18, wherein the one or more criteria comprise: the vehicle or the ECU transitioning to being powered off, the vehicle or the ECU transitioning to being in a suspended state, or the vehicle or the ECU transitioning to being in a low power mode.

Aspect 20: The apparatus according to any of Aspects 15-19, wherein the one or more criteria are relative to when the test was last performed.

Aspect 21: The apparatus according to any of Aspects 15-20, wherein: the one or more criteria are satisfied when a timer expires or when a counter reaches a threshold value; and the ECU is further configured to restart the timer or reset the counter, in response to performing the test associated with the ECU.

Aspect 22: The apparatus according to any of Aspects 15-21, wherein the ECU is further configured to: store a result associated with the test in a memory, check the stored result in response to obtaining an indication to resume the ECU from a suspended state, and perform one or more actions in response to checking the result.

Aspect 23: The apparatus of Aspect 22, wherein to perform the one or more actions, the ECU is configured to: perform one or more safety checks associated with the ECU while the ECU is in the suspended state and prevented from executing a safety application, and allow the ECU to resume from the suspended state in response to completing the one or more safety checks.

Aspect 24: The apparatus of Aspect 22 or 23, wherein the ECU is further configured to: determine that the result indicates an error associated with the ECU, perform a subsequent test in response to determining that the result indicates the error, and store a result of the subsequent test in the memory.

Aspect 25: The apparatus according to any of Aspects 22-24, wherein to perform the one or more actions, the ECU is further configured to: provide, to one or more other ECUs or an entity, an indication that the result indicates an error associated with the ECU, and prevent the ECU from booting.

Aspect 26: The apparatus according to any of Aspects 22-25, wherein the ECU is further configured to: detect an error associated with the ECU while the ECU is operating in the first state, reset or shutdown the ECU in response to detecting the error, detect an indication to power off the vehicle, perform another test associated with the ECU in response to detecting the error and to detecting the indication to power off the vehicle, allow the ECU to enter the suspended state if the other test passes, provide, to one or more other ECUs or an entity, an indication of the error associated with the ECU if the other test fails, and prevent the ECU from booting if the other test fails.

Aspect 27: The apparatus according to any of Aspects 22-26, wherein the ECU is further configured to operate in the suspended state, wherein the suspended state includes a suspend-to-memory state.

Aspect 28: The apparatus according to any of Aspects 15-27, wherein to operate the ECU in the first state, the ECU is configured to perform a safety operation and a non-safety operation.

Aspect 29: An apparatus for operating a vehicle, comprising: means for operating an electronic control unit (ECU) in a first state; means for detecting one or more criteria being satisfied to perform a test associated with the ECU; and means for performing the test associated with the ECU in response to detecting the one or more criteria being satisfied, while the ECU is in a second state different from the first state.

Aspect 30: An apparatus, comprising: a memory comprising computer-executable instructions; and one or more processors configured to execute the computer-executable instructions and cause the apparatus to perform a method in accordance with any of Aspects 1-14.

Aspect 31: An apparatus, comprising means for performing a method in accordance with any of Aspects 1-14.

Aspect 32: A non-transitory computer-readable medium comprising computer-executable instructions that, when executed by one or more processors of a processing system, cause the processing system to perform a method in accordance with any of Aspects 1-14.

Aspect 33: A computer program product embodied on a computer-readable storage medium comprising code for performing a method in accordance with any of Aspects 1-14.

### ADDITIONAL CONSIDERATIONS

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another-even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. A method of operating a vehicle, comprising:
operating an electronic control unit (ECU) in a first state;
detecting one or more criteria being satisfied to perform a test associated with the ECU; and
performing the test associated with the ECU in response to detecting the one or more criteria being satisfied, while the ECU is in a second state different from the first state.

2. The method of claim 1, wherein performing the test comprises performing a built-in self-test (BIST) associated with one or more electrical components or one or more software components of the ECU.

3. The method of claim 2, wherein the one or more electrical components include at least one of a memory, a processor, control logic, a power management circuit, or a voltage regulator.

4. The method of claim 1, wherein the second state comprises:
the vehicle or the ECU being powered off,
the vehicle or the ECU being in a suspended state,
the vehicle or the ECU not being in use for a duration,
the vehicle or the ECU being in a low power mode, or
a combination thereof.

5. The method of claim 1, wherein the one or more criteria comprise:
the vehicle or the ECU transitioning to being powered off,
the vehicle or the ECU transitioning to being in a suspended state, or
the vehicle or the ECU transitioning to being in a low power mode.

6. The method of claim 1, wherein the one or more criteria are relative to when the test was last performed.

7. The method of claim 1, wherein:
the one or more criteria are satisfied when a timer expires or when a counter reaches a threshold value; and
the method further comprises restarting the timer or resetting the counter, in response to performing the test associated with the ECU.

8. The method of claim 1, further comprising:
storing a result associated with the test in a memory;
checking the stored result in response to obtaining an indication to resume the ECU from a suspended state; and
performing one or more actions in response to checking the result.

9. The method of claim 8, wherein performing the one or more actions comprises:
performing one or more safety checks associated with the ECU while the ECU is in the suspended state and prevented from executing a safety application; and
allowing the ECU to resume from the suspended state in response to completing the one or more safety checks.

10. The method of claim 8, further comprising:
determining that the result indicates an error associated with the ECU;
performing a subsequent test in response to determining that the result indicates the error; and
storing a result of the subsequent test in the memory.

11. The method of claim 8, wherein performing the one or more actions comprises:
providing, to one or more other ECUs or an entity, an indication that the result indicates an error associated with the ECU; and
preventing the ECU from booting.

12. The method of claim 8, further comprising:
detecting an error associated with the ECU while the ECU is operating in the first state;
resetting or shutting down the ECU in response to detecting the error;
detecting an indication to power off the vehicle;
performing another test associated with the ECU in response to detecting the error and to detecting the indication to power off the vehicle;
allowing the ECU to enter the suspended state if the other test passes;
providing, to one or more other ECUs or an entity, an indication of the error associated with the ECU if the other test fails; and
preventing the ECU from booting if the other test fails.

13. The method of claim 8, further comprising operating the ECU in the suspended state, wherein the suspended state includes a suspend-to-memory state.

14. The method of claim 1, wherein operating the ECU in the first state comprises performing, via the ECU, a safety operation and a non-safety operation.

15. An apparatus for operating a vehicle, comprising:
an electronic control unit (ECU) configured to:
operate in a first state,
detect one or more criteria being satisfied to perform a test associated with the ECU, and
perform the test associated with the ECU in response to detecting the one or more criteria being satisfied, while the ECU is in a second state different from the first state.

16. The apparatus of claim 15, wherein to perform the test, the ECU is configured to perform a built-in self-test (BIST) associated with one or more electrical components or one or more software components of the ECU.

17. The apparatus of claim 16, wherein the one or more electrical components include at least one of a memory, a processor, control logic, a power management circuit, or a voltage regulator.

18. The apparatus of claim 15, wherein the second state comprises:
the vehicle or the ECU being powered off,
the vehicle or the ECU being in a suspended state,
the vehicle or the ECU not being in use for a duration,
the vehicle or the ECU being in a low power mode, or
a combination thereof.

19. The apparatus of claim 15, wherein the one or more criteria comprise:
the vehicle or the ECU transitioning to being powered off,
the vehicle or the ECU transitioning to being in a suspended state, or
the vehicle or the ECU transitioning to being in a low power mode.

20. The apparatus of claim 15, wherein the one or more criteria are relative to when the test was last performed.

21. The apparatus of claim 15, wherein:
the one or more criteria are satisfied when a timer expires or when a counter reaches a threshold value; and
the ECU is further configured to restart the timer or reset the counter, in response to performing the test associated with the ECU.

22. The apparatus of claim 15, wherein the ECU is further configured to:
store a result associated with the test in a memory,
check the stored result in response to obtaining an indication to resume the ECU from a suspended state, and
perform one or more actions in response to checking the result.

23. The apparatus of claim 22, wherein to perform the one or more actions, the ECU is configured to:
perform one or more safety checks associated with the ECU while the ECU is in the suspended state and prevented from executing a safety application, and
allow the ECU to resume from the suspended state in response to completing the one or more safety checks.

24. The apparatus of claim 22, wherein the ECU is further configured to:
determine that the result indicates an error associated with the ECU,
perform a subsequent test in response to determining that the result indicates the error, and
store a result of the subsequent test in the memory.

25. The apparatus of claim 22, wherein to perform the one or more actions, the ECU is further configured to:
provide, to one or more other ECUs or an entity, an indication that the result indicates an error associated with the ECU, and
prevent the ECU from booting.

26. The apparatus of claim 22, wherein the ECU is further configured to:
detect an error associated with the ECU while the ECU is operating in the first state,
reset or shutdown the ECU in response to detecting the error,
detect an indication to power off the vehicle,
perform another test associated with the ECU in response to detecting the error and to detecting the indication to power off the vehicle,
allow the ECU to enter the suspended state if the other test passes,
provide, to one or more other ECUs or an entity, an indication of the error associated with the ECU if the other test fails, and
prevent the ECU from booting if the other test fails.

27. The apparatus of claim 22, wherein the ECU is further configured to operate in the suspended state, wherein the suspended state includes a suspend-to-memory state.

28. The apparatus of claim 15, wherein to operate the ECU in the first state, the ECU is configured to perform a safety operation and a non-safety operation.

29. An apparatus for operating a vehicle, comprising:
means for operating an electronic control unit (ECU) in a first state;
means for detecting one or more criteria being satisfied to perform a test associated with the ECU; and
means for performing the test associated with the ECU in response to detecting the one or more criteria being satisfied, while the ECU is in a second state different from the first state.
